(19) United States
(12) Patent Application Publication
(10) Pub. No.: US 2026/0004444 A1
(43) Pub. Date: Jan. 1, 2026

(54) MULTI-MODAL STEREO VISION SYSTEM

(71) Applicant: Intrinsic Innovation LLC, Mountain View, CA (US)

(72) Inventors: Kartik Venkataraman, San Jose, CA (US); Agastya Kalra, Palo Alto, CA (US); Vage Taamazyan, Mountain View, CA (US); Alberto Dall'olio, Zurich (CH)

(21) Appl. No.: 19/254,796

(22) Filed: Jun. 30, 2025

Related U.S. Application Data
(60) Provisional application No. 63/665,939, filed on Jun. 28, 2024.

(51) Int. Cl. G06T 7/593; B25J 9/16; G06T 7/73; H04N 13/00; H04N 13/243

(52) U.S. Cl. CPC G06T 7/596; B25J 9/1666; B25J 9/1697; G06T 7/74; H04N 13/243; G06T 2207/10012; G06T 2207/10024; G06T 2207/10048; G06T 2207/20084; H04N 2013/0081

(57) ABSTRACT

A multi-modal stereo vision system includes one or more stereo vision units. Each stereo vision unit includes a plurality of stereo camera pairs. Each image pair includes a first image and a second image. The plurality of stereo camera pairs can capture multi-modal image data.

### CROSS-REFERENCE TO RELATED APPLICATIONS

This application claims priority to U.S. Provisional Application No. 63/665,939, filed on Jun. 28, 2024. The disclosure of the prior application is considered part of and is incorporated by reference in its entirety in the disclosure of this application.

### BACKGROUND

This specification relates to computer vision and robotic control and, in particular, to performing 3D reconstruction across complex geometries, environments, and materials in industrial settings for the purposes of robotic manipulation and collision avoidance.

A pixel correspondence between two images may indicate how pixels in a first image relate to pixels in a second image. The first image and the second image may be captured from different perspectives, and may thus provide different representations of an environment. A pair of pixels mapped to one another may represent the same portion of the environment, thus indicating an apparent displacement of the portion of the environment relative to the camera due to the different perspectives of the images. Pixel correspondences may be determined for and used in a plurality of different applications. In one example, a pixel correspondence between two simultaneously-captured images may be determined as part of a stereo disparity calculation.

### SUMMARY

This specification describes a multi-modal stereo vision system that includes one or more stereo vision units. Each stereo vision unit includes a plurality of stereo camera pairs. Each image pair includes a first (left) image and a second (right) image. The plurality of stereo camera pairs can capture multi-modal image data.

The subject matter described in this specification can be implemented in particular embodiments so as to realize one or more of the following advantages. A multi-modal stereo vision system, as described in this specification, can achieve high accuracy and robustness when determining pixel correspondence between a pair of stereo images. For example, the pixel correspondence can be determined as part of generating accurate 3-D reconstructions of scenes across complex geometries, environments, and materials. The multi-modal stereo vision system combines different techniques from fields of computer vision and machine learning, e.g., multi-baseline image data and multi-modal image data (e.g., high-resolution RGB image data, polarized image data, and infrared (IR) image data), an IR-dot based automatic stereo vision system calibration technique that obviates the need for capturing multiple images or using calibration target objects, and a deep learning architecture that effectively fuses multi-baseline and multi-modal image data, to improve the accuracy of the 3-D reconstruction.

Advantageously, the multi-modal stereo vision system as described in this specification can improve completeness while reducing hallucination even when generating 3-D reconstruction of challenging scenes in industrial settings that involve objects with complex geometries, e.g., objects that range from thin wires which are hard to see through, to tall bins which create occlusions and cause inter-reflections, adversarial materials, e.g., diffuse metals, anisotropic or transparent materials, and/or challenging lighting conditions, e.g., spotlight or dark conditions.

In implementations where the multi-modal stereo vision system is adopted in industrial robotics applications, the multi-modal stereo vision system can facilitate more precise robotic manipulation by a robot and safer trajectory planning for collision avoidance, where the latter can avoid unnecessary wear and tear on and damage to other objects in a workcell and the robot itself. In further implementations the multi-modal stereo vision system can facilitate other robotic vision tasks, including allowing for more accurate object pose estimation, more accurate grasp estimation, development of more robust robot control algorithms, e.g., through reinforcement learning, and so forth.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a multimodal stereo vision system in relation to a computer vision system, a robot control system, and a workcell.

FIG. 2 shows an example of a stereo vision unit.

FIG. 3 is an example illustration of operations performed by a computer vision system.

FIG. 4 is a flow diagram of an example process for generating a pixel correspondence.

Like reference numbers and designations in the various drawings indicate like elements.

### DETAILED DESCRIPTION

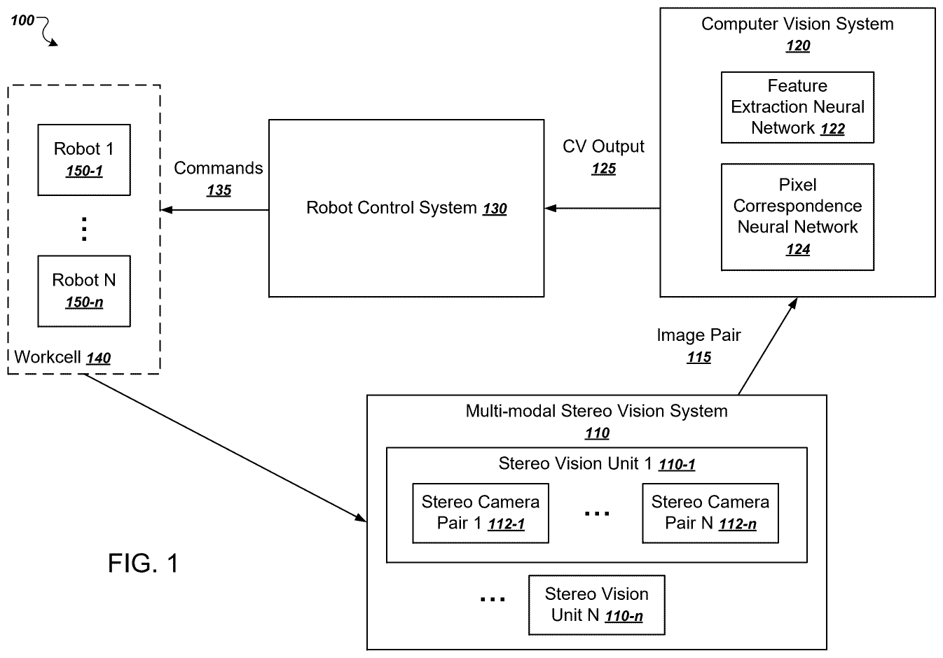

FIG. 1 is a block diagram 100 of a multi-modal stereo vision system 110 in relation to a computer vision system 120, a robot control system 130, and a workcell 140. The multi-modal stereo vision system 110, the computer vision system 120, the robot control system 130, and the workcell 140 are in wired and/or wireless communication with each other.

The multi-modal stereo vision system 110 includes one or more stereo vision units, e.g., stereo vision unit 1 110-1 through stereo vision unit N 110-n. Each stereo vision unit includes a plurality of stereo camera pairs, e.g., stereo camera pair 1 112-1 through stereo camera pair N 112-n. Each camera pair includes a first (left) camera and a second (right) camera that can capture an image pair 115 that includes a first (left) image and a second (right) image.

The plurality of stereo camera pairs can capture image pairs that include images in different modalities (although the left and right cameras in the same pair typically capture images in the same modality). Thus, the plurality of stereo camera pairs can capture multi-modal image data.

That is, the plurality of stereo camera pairs can include a first stereo camera pair that can capture a first image pair that includes a left image and a right image that are in a first modality, a second stereo camera pair that can capture a second image pair that includes a left image and a right image that are in a second modality, and so forth, wherein the first modality and the second modality are different from each other.

In this specification, a data “modality” refers to a type of data that is generated using a specific sensor, e.g., a type of images that are captured by a specific camera. A few examples of possible modalities are described next. In some implementations, the plurality of stereo camera pairs can include two or more stereo of these camera pairs that can capture images in two or more of these modalities.

For example, a stereo camera pair can include non-polarized red-green-blue (RGB) cameras, i.e., a left non-polarized RGB camera and a right non-polarized RGB camera, that can capture non-polarized red-green-blue (RGB) images, i.e., a left non-polarized RGB image and a right non-polarized RGB image. As a similar example, a stereo camera pair can include non-polarized monochrome cameras that can capture non-polarized monochrome images. As another example, a stereo camera pair can include polarized red-green-blue (RGB) cameras that can capture polarized red-green-blue (RGB) images. As a similar example, a stereo camera pair can include polarized monochrome cameras that can capture polarized monochrome images. As another example, a stereo camera pair can include infrared (IR) cameras that can capture infrared (IR) images. As another example, a stereo camera pair can include depth cameras that can capture depth images.

The computer vision system 120 and the robot control system 130 are examples of a system implemented as computer programs on one or more computers in one or more locations, in which the systems, components, and techniques described below can be implemented.

The workcell 140 includes one or more robots, e.g., robot 1 150-1 through robot N 150-n. Each robot includes one or more operational components. Examples of operational components include end effectors and actuators or other servo motors that effectuate movement of one or more components, e.g., links or arms, of a robot. For example, the robot can have multiple degrees of freedom and each of the actuators can control actuation of the robot within one or more of the degrees of freedom responsive to the commands 135.

The term “actuator” as used throughout the specification refers to a mechanical or electrical device that creates motion (e.g., a motor), in addition to any driver(s) that may be associated with the actuator and that translate received control commands into one or more signals for driving the actuator. Accordingly, providing a command to an actuator may include providing the command to a driver that translates the command into appropriate signals for driving an electrical or mechanical device to create desired motion.

Despite being described as being logically separate from each other, the multi-modal stereo vision system 110 can be physically adjacent to or integral with the workcell 140. In some implementations, the multi-modal stereo vision system 110 is affixed to a stationary surface of the workcell 140. For example, the multi-modal stereo vision system 110 can be mounted on the ceiling of the workcell 140 that is facing toward the workcell 140 from a distance above, such that the one or more robots are within a field of view of the plurality of stereo camera pairs of the multi-modal stereo vision system 110.

The robot control system 130 is configured to generate the commands 135 that control the movement of the operational components of the one or more robots, e.g., robot 1 150-1 through robot N 150-n. The robot control system 130 generates the commands 135 based on a computer vision output 125 generated by the computer vision system 120.

Although robot control system 130 is illustrated in FIG. 1 as being separate from the workcell 140, this is not request in all implementations. For example, in some implementations, the robot control system 130 can be integral with a robot, e.g., it can be an embedded control system, or can be implemented in a component that is separate from the robot, but within the physical boundary of the workcell 140.

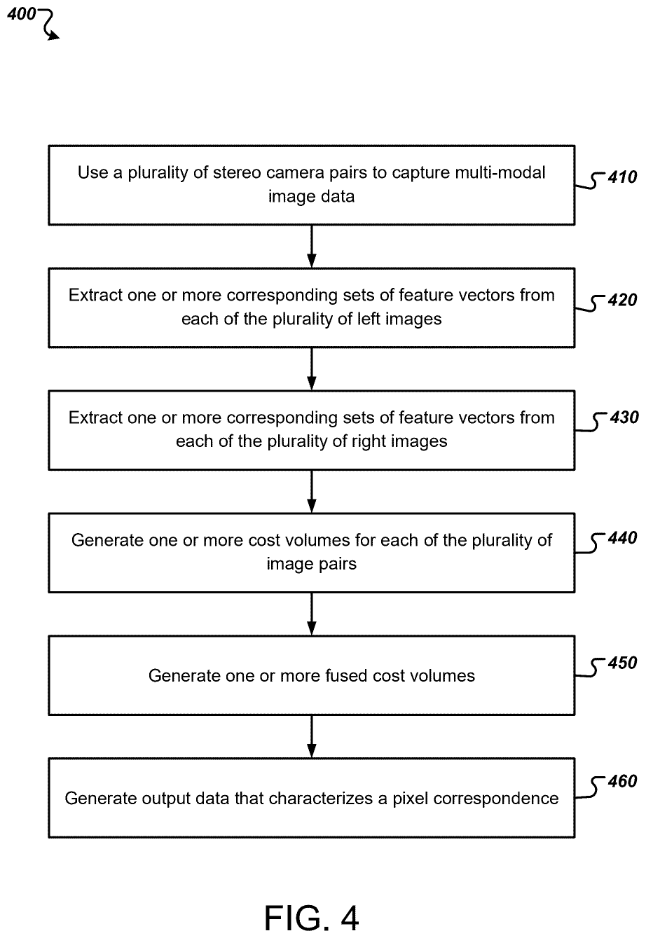

The computer vision system 120 uses the multi-modal image data generated by the multi-modal stereo vision system 110 to determine a pixel correspondence, i.e., a correspondence between pixels in a left image and pixels in a right image in an image pair 115, which can be any image pair or any combination of image pairs in the plurality of image pairs generated by the multi-modal stereo vision system 110. Determining the pixel correspondence will be explained further below with reference to FIGS. 4-5.

In implementations, the pixel correspondence can be determined as part of a computer vision task that the computer vision system 120 is configured to perform. The computer vision system 120 can be configured to perform any of a variety of computer vision tasks on the multi-modal image data to generate any of the variety of computer vision outputs 125.

For example, the pixel correspondence can be determined as part of the generation of a disparity map of a scene, e.g., the workcell 140. In this example, the computer vision output 125 generated by the computer vision system 120 can include the disparity map of the scene. In some implementations, a disparity map is a two-dimensional (2-D) image that has pixels, where the intensity of each pixel represents the disparity of the corresponding physical point in the scene that is represented by the pixel.

Disparity is the apparent horizontal shift of a point between two images taken from slightly different viewpoints (a first viewpoint corresponding to the left camera and a second viewpoint corresponding to the right camera). The closer an object is, the larger its disparity (it shifts more between the two images). The farther away an object is, the smaller its disparity.

Once the computer vision system 120 finds the corresponding pixel in the right image for each pixel in the left image, the horizontal difference in their x-coordinates is the disparity. Thus, a disparity map is essentially a visualization of these pixel correspondences and their horizontal displacement.

As another example, the pixel correspondence can be determined as part of the generation of a depth map of the scene, e.g., the workcell 140. In this example, the computer vision output 125 generated by the computer vision system 120 can include the depth map of the scene. In some implementations, a depth map is a 2D image that has pixels, where each pixel's value represents the depth of the corresponding physical point in the scene that is represented by the pixel, i.e., the distance of the corresponding physical point from a camera.

In some implementations, the depth map can be generated based on the disparity map. While disparity is a direct result of pixel correspondence, depth is derived from disparity using known camera parameters (focal length, baseline distance between cameras) and the principle of triangulation. For example, the formula that can be used by the computer vision system 120 to compute depth (Z) from disparity (d) can be: Z=(f×B)/d, where f is the focal length and B is the baseline. A baseline is a distance between the optical centers of two cameras in a stereo camera pair. The two cameras can be used to capture images of the same scene.

As another example, the pixel correspondence can be determined as part of the generation of a three-dimensional (3-D) reconstruction of the scene, e.g., the workcell 140. 3D reconstruction is the process of creating a 3-D model of the scene from 2-D images. In this example, the computer vision output 125 generated by the computer vision system 120 can thus include a 3-D model, e.g., a point cloud, mesh, or volumetric representation, of the workcell 140, or a real-world object located inside the workcell 140.

In some implementations, the 3-D reconstruction of the scene can be generated based on the disparity map and the depth map. As mentioned above, pixel correspondences allow the calculation of disparity and then depth. Each pixel in the image, now with an associated depth value, can be projected back into 3-D space, forming a dense point cloud that represents the scene's geometry.

To perform the computer vision task, the computer vision system 120 includes one or more feature extraction neural networks 122 and a disparity map neural network 124.

Each feature extraction neural network 122 is a neural network having parameters and that is configured to process, in accordance with the parameters of the feature extraction neural network 122, an image to generate a corresponding set of feature vectors for the image. For example, the feature extraction neural network 122 can generate a feature map that includes a respective feature vector for each of a plurality of locations in the image.

In some implementations, the computer vision system 120 includes a single feature extraction neural network 122 that is shared across different modalities, such that the shared feature extraction neural network is used to process the left (or right) images captured by all of the left (or right) cameras included in the plurality of stereo camera pairs to generate a corresponding set of feature vectors for each left image.

In some implementations, the computer vision system 120 includes multiple feature extraction neural networks 122. For example, the computer vision system 120 can use different feature extraction neural networks 122 to process images in different modalities that are captured by different cameras.

The feature extraction neural network 122 can have any appropriate architecture, e.g., a convolutional architecture, a fully-connected architecture, a transformer architecture, or any other appropriate neural network architecture, that allows the neural network to extract a set of feature vectors from an image.

The disparity map neural network 124 is a neural network having parameters and that can be used to generate a disparity map. The disparity map neural network 124 is configured to process, in accordance with the parameters of the disparity map neural network 124, an input that includes (i) data retrieved from a fused cost volume in accordance with a disparity scale parameter and (ii) a current estimation of the disparity map to generate an output that defines an update to the current estimation of the disparity map.

The disparity map neural network 124 can have any appropriate architecture, e.g., a convolutional architecture, a fully-connected architecture, a recurrent architecture, a transformer architecture, or any other appropriate neural network architecture, that allows the neural network to generate an updated estimation of the disparity map.

As a particular example, the disparity map neural network 124 can be configured as a recurrent neural network. For example, the disparity map neural network 124 can be a long short-term memory (LSTM) recurrent neural network (that includes one or more LSTM neural network layers), or a gated recurrent unit (GRU) recurrent neural network (that includes one or more GRU neural network layers).

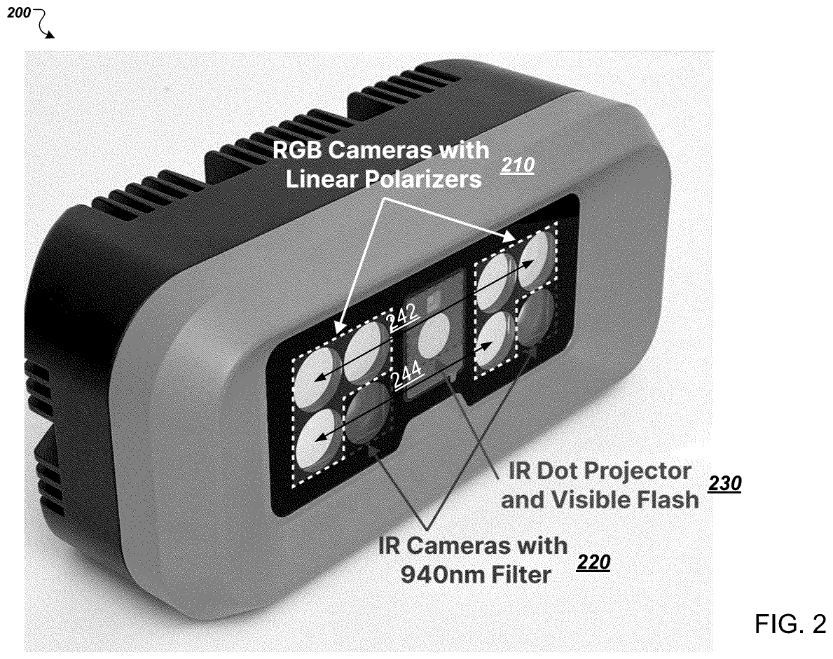

FIG. 2 shows an example of a stereo vision unit 200. The stereo vision unit 200 is an example of a device that can be used to implement the computer vision and/or robotic control techniques described in this specification.

The stereo vision unit 200 includes a total of four stereo camera pairs: three pairs of polarized RGB cameras (RGB cameras with linear polarizers) 210, and one pair of infrared cameras (IR cameras with 940 nm filter) 220. The stereo vision unit 200 also includes a combination 230 of an IR dot projector and a flashlight that emits visible light. Equipped with these four stereo camera pairs, the stereo vision unit 200 can thus capture multi-modal image data that includes polarized RGB images and IR images.

Each stereo camera pair includes a left camera and a right camera. The plurality of stereo camera pairs can have different baselines. For example, FIG. 2 shows that the four stereo camera pairs include a first stereo camera pair which includes a left polarized RGB camera and a right polarized RGB camera that are separated from each other by a first distance 242, and a second stereo camera pair which includes a left polarized RGB camera and a right polarized RGB camera that are separated from each other by a second distance 244, where the first distance 242 is different from (greater than) the second distance 244.

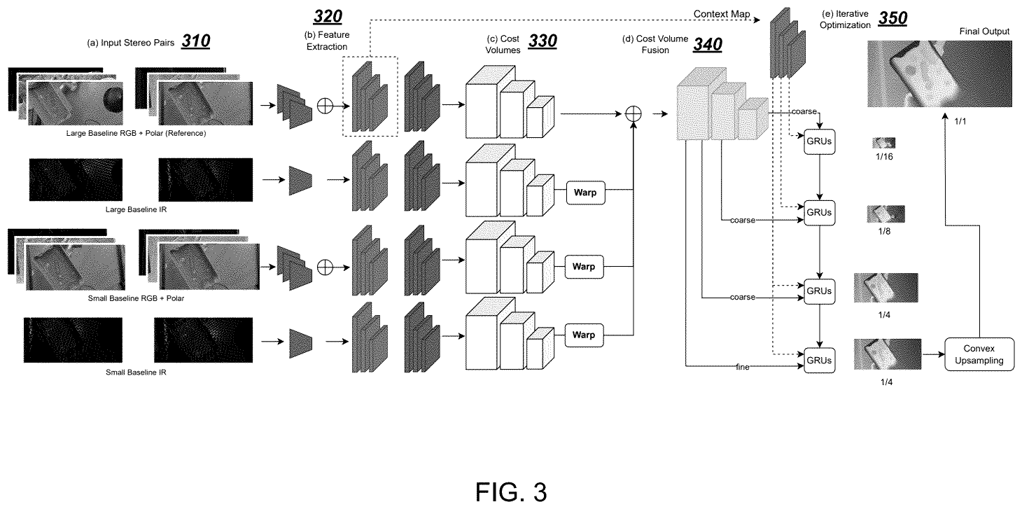

FIG. 3 is an example illustration of operations performed by the computer vision system 120. These operations are logically grouped into a sequence of stages: an input stage 310, a feature extraction stage 320, a cost volume generation stage 330, a cost volume fusion stage 340, and an optimization stage 350.

At the input stage 310, the computer vision system 120 receives a plurality of image pairs generated by the multi-modal stereo vision system 110. Each image pair includes a left image and a right image. For example, the plurality of image pairs can include two or more of: a pair of non-polarized RGB images, a pair of non-polarized monochrome images, a pair of polarized RGB images, a pair of polarized monochrome images, or a pair of IR images.

At the feature extraction stage 320, the computer vision system 120 processes each received image using a feature extraction neural network 122 to generate a corresponding set of feature vectors for the image. For example, the feature extraction neural network 122 can generate a feature map that includes a respective feature vector for each of a plurality of locations in the image.

In some implementations, the computer vision system 120 uses one or more feature extraction neural networks 120 to map an image having an input resolution to multiple feature maps that have different resolutions. The resolutions of these feature maps are typically lower than the input resolution of the image. Thus, each location in a feature map corresponds to a different region of multiple pixels in the image.

For example, the computer vision system 120 can use one or more feature extraction neural networks 120 to map the image to a first feature map that has a first lower resolution than the input image, e.g., that is 1/16 of the input resolution of the image; map the image to a second feature map that has a second lower resolution than the input image, e.g., that is ⅛ of the input resolution of the image; and map the image to a third feature map that has a third lower resolution than the input image, e.g., that is ¼ of the input resolution of the image.

At the cost volume generation stage 330, the computer vision system 120 generates one or more cost volumes for each of the plurality of image pairs. For each image pair that includes a left image and a right image, a cost volume includes cost values that are computed based on (i) one or more feature vectors of a corresponding set of feature vectors extracted from the left image and (ii) one or more feature vectors of a corresponding set of feature vectors extracted from the right image.

In some implementations, a cost volume can include cost values that are computed based on determining a combination, e.g., concatenation, of (i) one or more feature vectors included in a feature map generated from the left image and (ii) one or more feature vectors of a corresponding set of feature vectors included in a feature map generated from the right image. In some implementations, a cost volume can include cost values that are computed based on determining a correlation (e.g., a dot product or other similarity measure, e.g., cosine similarity) between (i) and (ii). In some implementations, a cost volume can include cost values that are computed based on determining a difference between (i) and (ii).

In some implementations, for each image pair, the computer vision system 120 generates a cost volume corresponding to each of the different resolutions of the multiple feature maps. These multiple cost volumes thus correspond to different levels of detail.

For example, for a pair of non-polarized RGB images, the computer vision system 120 can generate a first cost volume corresponding to the first lower resolution, e.g., that is 1/16 of the input resolution of the image, a second cost volume corresponding to the second lower resolution, e.g., that is ⅛ of the input resolution of the image, and a third cost volume corresponding to the third lower resolution, e.g., that is ¼ of the input resolution of the image.

At the cost volume fusion stage 340, the computer vision system 120 generates one or more fused cost volumes. The one or more fused cost volumes are generated with respect to a reference image pair. The reference image pair can be any one of the plurality of image pairs generated by the multi-modal stereo vision system 110. For example, the reference image pair can correspond to the pair of images that are generated by a camera pair that has the largest (or smallest) baseline among all camera pairs included in the multi-modal stereo vision system 110.

In some implementations, the computer vision system 120 generates a fused cost volume corresponding to each of the different resolutions of the multiple feature maps. For example, the computer vision system 120 can generate a first fused cost volume corresponding to the first lower resolution, e.g., that is 1/16 of the input resolution of the image, a second fused cost volume corresponding to the second lower resolution, e.g., that is ⅛ of the input resolution of the image, and a third fused cost volume corresponding to the third lower resolution, e.g., that is ¼ of the input resolution of the image.

A fused cost volume is generated by the computer vision system 120 from a plurality of cost volumes (that correspond to the same feature map resolution) that have been generated for the plurality of image pairs.

To generate the fused cost volume, the computer vision system 120 determines a reference three-dimensional (3-D) location of each element that corresponds to a respective image pixel within the cost volume generated for the reference image pair. Then, for each additional image pair in the plurality of image pairs, the computer vision system 120 determines an additional 3-D location of each element in an additional (non-reference) cost volume generated for the additional image pair. That is, the system finds the corresponding 3-D locations of same element that corresponds to the same pixel in the other cost volumes that have been generated for the remaining image pairs. For example, the system can do this by using the calibration data which contains information about the relative positions and orientations of the stereo camera pairs.

The computer vision system 120 generates a mapping between (i) the reference 3-D location of each element in the cost volume generated for the reference image pair and (ii) the additional 3-D location of each element in the additional cost volume generated for each additional image pair. For example, the mapping can be a 3-D mapping.

Next, the computer vision system 120 warps the additional cost volume generated for each additional image pair with reference to the cost volume generated for the reference image pair in accordance with the mapping. This improves the alignment of the additional cost volumes with the cost volume generated for the reference image pair. For example, the system can use bilinear interpolation to perform the warping.

Once all cost volumes are warped and aligned, the computer vision system 120 combines, e.g., sums, all of the cost volumes (including the cost volume generated for the reference image pair and the additional cost volume generated for each additional image pair) to generate the fused cost volume. In doing so the system fuses all the information that is made available to it, thereby creating a comprehensive cost volume that benefits from the multi-modal and multi-baseline image data, for example mitigating noise in large baseline cost volumes by fusing small baseline ones while retaining the accuracy benefits of the larger baseline.

At the optimization stage 350, the computer vision system 120 performs an iterative optimization process to generate a computer vision output 125. In some implementations, the computer vision output 125 includes a disparity map. The disparity map is generated with respect to a reference image in the reference image pair. The reference image can be any one of two images in the reference image pair. For example, the reference image can be left image in the reference image pair.

The iterative optimization process includes a plurality of iterations. At each iteration, the computer vision system 120 generate an updated estimation of the disparity map by using the disparity map neural network 124 which can, for example, be configured as a recurrent neural network.

At each iteration, the disparity map neural network 124 is configured to process an input that includes (i) data retrieved from a fused cost volume in accordance with a disparity scale parameter and (ii) a current estimation of the disparity map to generate an output that defines an update to the current estimation of the disparity map.

For the first iteration, the current estimation of the disparity map is an initial estimation of the disparity map. For any subsequent iteration, the current estimation of the disparity map is an updated estimation of the disparity map that is generated based on the output of the disparity map neural network 124 in the immediately preceding iteration.

In particular, the computer vision system 120 incorporates the disparity scale parameter into the query from the disparity map neural network 124 to a fused cost volume. This parameter dynamically adjusts the sampling intervals (or stride along the disparity dimension) within the fused cost volume, enabling a coarse-to-fine search strategy. By exploring the fused cost volume at a coarse interval in the earlier iterations and then exploring the fused cost volume at a fine interval at the later iterations, the computer vision system 120 effectively navigate the expansive disparity space to enable the disparity map neural network 124 to handle large disparity ranges.

For example, at each of one or more first iterations, the disparity map neural network 124 can process an input that includes (i) the first cost volume corresponding to the first lower resolution and (ii) a disparity scale parameter has a first value.

Then, at each of one or more second iterations that follow the one or more first iterations, the disparity map neural network 124 can process an input that includes (i) the first cost volume corresponding to the second lower resolution and (ii) a disparity scale parameter has a second value. The second value is smaller than the first value.

At each iteration, the computer vision system 120 retrieves, for each pixel in the reference image in the reference image pair, a corresponding set feature vectors from the fused cost volume. In particular, the system performs the retrieval by sampling (e.g., by way of interpolation, e.g., bilinear interpolation) from the fused cost volume in accordance with the disparity scale parameter. In the example above, since the second value is smaller than the first value, the computer vision system 120 can retrieve a greater number of, but more closely spaced feature vectors along the disparity dimension for each pixel at each of the one or more second iterations.

At each iteration, the computer vision system 120 provides (i) the data that includes the corresponding sets feature vectors retrieved from the fused cost volume in accordance with the disparity scale parameter and (ii) a current estimation of the disparity map as input to the disparity map neural network 124.

The disparity map neural network 124 then processes the input to update a current hidden state of the neural network to generate an updated hidden state by processing the received input, i.e., to modify the current hidden state of the neural network, which has been generated by processing the previous inputs received at the preceding iterations, by processing the current received input. The disparity map neural network 124 then uses the updated hidden state to generate an output that defines an update (or residual) to the current estimation of the disparity map. Correspondingly, the computer vision system 120 can update the current estimation of the disparity map in accordance with the update defined by the output of the disparity map neural network 124 to generate the updated estimation of the disparity map.

The updated estimation of the disparity map that is generated in the last iteration of the optimization process can then be used by the computer vision system 120 to generate a final disparity map. The final disparity map will then be provided by the system as the computer vision output 125.

In particular, the computer vision system 120 applies further processing on the updated estimation of the disparity map generated in the last iteration to generate the final disparity map. For example, because each fused cost volume corresponds to a resolution lower than the input resolution of the images, the computer vision system 120 can apply upsampling, e.g., convex upsampling, to the updated estimation to generate a final disparity map that corresponds to the same input resolution as the images.

FIG. 4 is a flow diagram of an example process 400 for generating a pixel correspondence. For convenience, the process 400 will be described as being performed by a system of one or more computers located in one or more locations. For example, a computer vision system, e.g., the computer vision system 120 depicted in FIG. 1, appropriately programmed in accordance with this specification, can perform the process 400.

The computer vision system uses a multi-modal stereo vision system to capture multi-modal image data (410). For example, the multi-modal stereo vision system can be the multi-modal stereo vision system 110 of FIG. 1. The multi-modal stereo vision system includes one or more stereo vision units. Each stereo vision unit includes a plurality of stereo camera pairs. For example, the plurality of stereo camera pairs can include two or more of: a pair of non-polarized RGB cameras, a pair of non-polarized monochrome cameras, a pair of polarized RGB cameras, a pair of polarized monochrome cameras or a pair of IR cameras.

The computer vision system can thus use the multi-modal stereo vision system to capture multi-modal image data. The multi-modal image data includes a plurality of image pairs captured by the plurality of stereo camera pairs. Each image pair includes a left image and a right image. The plurality of image pairs include images in two or more modalities. For example, the plurality of image pairs can include two or more of: a pair of non-polarized RGB images, a pair of non-polarized monochrome images, a pair of polarized RGB images, a pair of polarized monochrome images, or a pair of IR images.

The computer vision system extracts, at each of a plurality of different resolutions, a corresponding set of feature vectors from the left image in each of the plurality of image pairs (420). In some implementations, the computer vision system does this by using a shared feature extraction neural network to map the left image to different feature maps that have different resolutions. Each feature map includes a respective feature vector for each of a plurality of locations in the left image.

The computer vision system extracts, at each of the plurality of different resolutions, a corresponding set of feature vectors from the right image in each of the plurality of image pairs (430). In some implementations, the computer vision system does this by using the shared feature extraction neural network to map the right image to different feature maps that have different resolutions. Each feature map includes a respective feature vector for each of a plurality of locations in the right image.

The computer vision system generates one or more cost volumes for each of the plurality of image pairs (440). For each image pair that includes a left image and a right image, a cost volume includes cost values that are computed based on (i) one or more feature vectors of a corresponding set of feature vectors extracted from the left image and (ii) one or more feature vectors of a corresponding set of feature vectors extracted from the right image. In some implementations, for each image pair, the computer vision system generates a cost volume corresponding to each of the different resolutions of the multiple feature maps.

The computer vision system generates one or more fused cost volumes from the one or more cost volumes generated for each of the plurality of image pairs (450). The one or more fused cost volumes are generated with respect to a reference image pair. The reference image pair can be any one of the plurality of image pairs generated by the multi-modal stereo vision system.

A fused cost volume is generated from a plurality of cost volumes (that correspond to the same feature map resolution) that have been generated for the plurality of image pairs. In some implementations, the computer vision system generates a fused cost volume corresponding to each of the different resolutions of the multiple feature maps.

The computer vision system generates, based on the one or more fused cost volumes, a computer vision output that characterizes a pixel correspondence between a left image and a right image in the reference image pair (460). In some implementations, the computer vision output includes a disparity map. The disparity map is generated with respect to a reference image in the reference image pair. The reference image can be any one of two images in the reference image pair.

In some implementations, the computer vision system performs an iterative optimization process by using a disparity map neural network to iteratively update an initial estimation of the disparity map, and then applies upsampling on the updated estimation of the disparity map that is generated in the last iteration to generate the final disparity map.

In some implementations, the computer vision output includes a depth map. The depth map can be generated based on the disparity map. In some implementations, the computer vision output includes a 3-D reconstruction of a scene. For example, the computer vision output can include a point cloud, mesh, or volumetric representation of the scene. In some of these implementations, the computer vision system can provide the computer vision output to a robot control system—and the robot control system uses the 3-D reconstruction of the scene to generate one or more commands to control a robot.

Such a 3-D reconstruction generated by the computer vision system from the multi-modal image data generated by using multi-modal stereo vision system provides rich spatial information about the scene, e.g., information about the obstacles (walls, workpieces, other robots) and their exact location, size, and shape, which is invaluable for controlling the robot in various complex tasks.

For example, the robot control system can generate commands for the robot to follow a collision-free path, e.g., that can navigate around detected obstacles, when navigating within the scene. As another example, the robot control system can generate commands for the robot to more robustly perform object manipulation and grasping, e.g., by grasping onto optimal grasp points on the object surface that are stable and moving the robot to reach the object without collision.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

1. A method comprising:
using a plurality of stereo camera pairs to capture multi-modal image data, wherein the multi-modal image data comprises a plurality of image pairs, wherein each image pair comprises a left image and a right image, and wherein the plurality of left images are in two or more modalities;
extracting a corresponding set of feature vectors from each of the plurality of left images;
extracting a corresponding set of feature vectors from each of the plurality of right images;
generating a cost volume for each of the plurality of image pairs, wherein for each image pair, the cost volume includes cost values between one or more feature vectors of the corresponding set of feature vectors extracted from the left image and one or more feature vectors of the corresponding set of feature vectors extracted from the right image;
generating a fused cost volume from the cost volume generated for each of the plurality of image pairs; and
generating, based on the fused cost volume, output data that characterizes a pixel correspondence between a left image and a right image in at least one of the plurality of image pairs.

2. The method of claim 1, wherein generating the fused cost volume comprises:
for a reference image pair in the plurality of image pairs, determining a reference three-dimensional (3-D) location of each element in the cost volume generated for the reference image pair; and
for each additional image pair in the plurality of image pairs:
determining an additional 3-D location of each element in the cost volume generated for the additional image pair;
generating a mapping between (i) the reference 3-D location of each element in the cost volume generated for the reference image pair and (ii) the additional 3-D location of each element in the cost volume generated for the additional image pair; and
warping the cost volume generated for the additional image pair with reference to the cost volume generated for the reference image pair in accordance with the mapping.

3. The method of claim 1, wherein extracting the corresponding set of feature vectors from each of the plurality of left images comprises:
processing each of the plurality of left images using a shared feature extraction neural network to generate the corresponding set of feature vectors for each of the plurality of left images.

4. The method of claim 1, wherein generating the cost volume for each of the plurality of image pairs comprises a plurality of cost volumes for each of the plurality of image pairs, each cost volume corresponding to a different resolution.

5. The method of claim 1, wherein the plurality of left images comprise two or more of: a non-polarized red-green-blue (RGB) image, a polarized red-green-blue (RGB), or an infrared (IR) image.

6. The method of claim 5, wherein generating the output data that characterizes the pixel correspondence between the left image and the right image comprises:
generating a disparity map based on a correspondence between pixels in the left image and pixels in the right image.

7. The method of claim 6, wherein generating the output data that characterizes the pixel correspondence between the left image and the right image comprises:
generating a depth map that defines a depth for each pixel in the left image, a depth map that defines a depth for each pixel in the right image, or both based on the disparity map.

8. The method of claim 7, wherein generating the output data that characterizes the pixel correspondence between the left image and the right image comprises:
generating a 3-D reconstruction of a scene based on the depth map; and
generating one or more commands to control a robot to manipulate an object based on the 3-D reconstruction of the scene.

9. The method of claim 6, wherein generating the output data comprises:
executing an iterative optimization process comprising a plurality of iterations to generate the disparity map from an initial estimation of the disparity map.

10. The method of claim 9, wherein executing the iterative optimization process comprises, at each iteration:
processing an input comprising data retrieved from the fused cost volume in accordance with a disparity scale parameter using a neural network to generate an update to a current estimation of the disparity map.

11. The method of claim 10, wherein the disparity scale parameter has a greater value at an earlier optimization iteration than at a later optimization iteration.

12. The method of claim 10, wherein the neural network comprises a recurrent neural network.

13. A system comprising one or more computers and one or more storage devices storing instructions that, when executed by the one or more computers, cause the one or more computers to perform operations comprising:
using a plurality of stereo camera pairs to capture multi-modal image data, wherein the multi-modal image data comprises a plurality of image pairs, wherein each image pair comprises a left image and a right image, and wherein the plurality of left images are in two or more modalities;
extracting a corresponding set of feature vectors from each of the plurality of left images; extracting a corresponding set of feature vectors from each of the plurality of right images;
generating a cost volume for each of the plurality of image pairs, wherein for each image pair, the cost volume includes cost values between one or more feature vectors of the corresponding set of feature vectors extracted from the left image and one or more feature vectors of the corresponding set of feature vectors extracted from the right image;
generating a fused cost volume from the cost volume generated for each of the plurality of image pairs; and
generating, based on the fused cost volume, output data that characterizes a pixel correspondence between a left image and a right image in at least one of the plurality of image pairs.

14. The system of claim 13, wherein generating the fused cost volume comprises:
for a reference image pair in the plurality of image pairs, determining a reference three-dimensional (3-D) location of each element in the cost volume generated for the reference image pair; and
for each additional image pair in the plurality of image pairs:
determining an additional 3-D location of each element in the cost volume generated for the additional image pair;
generating a mapping between (i) the reference 3-D location of each element in the cost volume generated for the reference image pair and (ii) the additional 3-D location of each element in the cost volume generated for the additional image pair; and
warping the cost volume generated for the additional image pair with reference to the cost volume generated for the reference image pair in accordance with the mapping.

15. The system of claim 13, wherein extracting the corresponding set of feature vectors from each of the plurality of left images comprises:
processing each of the plurality of left images using a shared feature extraction neural network to generate the corresponding set of feature vectors for each of the plurality of left images.

16. The system of claim 13, wherein generating the cost volume for each of the plurality of image pairs comprises a plurality of cost volumes for each of the plurality of image pairs, each cost volume corresponding to a different resolution.

17. The system of claim 13, wherein the plurality of left images comprise two or more of: a non-polarized red-green-blue (RGB) image, a polarized red-green-blue (RGB), or an infrared (IR) image.

18. The system of claim 13, wherein generating the output data that characterizes the pixel correspondence between the left image and the right image comprises:
generating a disparity map based on a correspondence between pixels in the left image and pixels in the right image.

19. The system of claim 18, wherein generating the output data comprises:
executing an iterative optimization process comprising a plurality of iterations to generate the disparity map from an initial estimation of the disparity map.

20. One or more non-transitory computer storage media storing instructions that, when executed by one or more computers, cause the one or more computers to perform operations comprising:
using a plurality of stereo camera pairs to capture multi-modal image data, wherein the multi-modal image data comprises a plurality of image pairs, wherein each image pair comprises a left image and a right image, and wherein the plurality of left images are in two or more modalities;
extracting a corresponding set of feature vectors from each of the plurality of left images; extracting a corresponding set of feature vectors from each of the plurality of right images;
generating a cost volume for each of the plurality of image pairs, wherein for each image pair, the cost volume includes cost values between one or more feature vectors of the corresponding set of feature vectors extracted from the left image and one or more feature vectors of the corresponding set of feature vectors extracted from the right image;
generating a fused cost volume from the cost volume generated for each of the plurality of image pairs; and
generating, based on the fused cost volume, output data that characterizes a pixel correspondence between a left image and a right image in at least one of the plurality of image pairs.
